(19) United States
(12) Patent Application Publication
(10) Pub. No.: US 2025/0063391 A1
(43) Pub. Date: Feb. 20, 2025

(54) BASE STATION DEVICE, WIRELESS TERMINAL DEVICE, WIRELESS COMMUNICATION SYSTEM, AND COMMUNICATION CONTROL METHOD

(71) Applicant: FUJITSU LIMITED, Kawasaki-shi (JP)

(72) Inventors: Tetsuya YANO, Yokohama (JP); YOSHIHIRO KAWASAKI, Kawasaki (JP)

(73) Assignee: FUJITSU LIMITED, Kawasaki-shi (JP)

(21) Appl. No.: 18/937,110

(22) Filed: Nov. 5, 2024

Related U.S. Application Data
(63) Continuation of application No. PCT/JP2022/022094, filed on May 31, 2022.

(51) Int. Cl. H04W 24/02

(52) U.S. Cl. CPC H04W 24/02

(57) ABSTRACT

A base station device includes a plurality of wireless stations, the wireless stations each includes: a receiver that receives signals transmitted from a plurality of wireless terminal devices that transmit transmission data in a coordinated manner, and a controller that selects a reference wireless station from among the wireless stations, determines a phase of the transmission data for each of the wireless terminal devices at the selected reference wireless station, and notifies the wireless terminal devices of the determined phase.

### CROSS-REFERENCE TO RELATED APPLICATION

This application is a continuation of International Application No. PCT/JP2022/022094, filed on May 31, 2022, the entire contents of which are incorporated herein by reference.

### FIELD

The embodiments discussed herein are related to a base station device, a wireless terminal device, and a wireless communication system.

### BACKGROUND

The 3rd Generation Partnership Project (3GPP) (registered trademark), which develops standards for wireless communications, is currently conducting technical studies on communication standards for the fifth-generation mobile communications (5G or NR (New Radio)). In the current networks targeted for the fifth-generation mobile communications, for example, traffic from mobile terminals such as smartphones and future phones accounts for the majority of network resources. The traffic used by mobile terminals tends to grow in the future.

On the other hand, as Internet of things (IoT) services are deployed, it is desired to respond to a wide variety of services with diverse requirements. Technologies that implement even higher data rates, higher capacity, and lower latency are therefore important for the communication standards for the fifth-generation mobile communications.

In particular, communication performance in the uplink direction (uplink) from a wireless terminal device to a base station device can be a serious bottleneck in a wireless system in NR. Therefore, NR needs higher uplink communication performance in terms of coverage, throughput, and service continuity. For example, for information transmission by users using various wireless terminal devices and uploading of rich content such as video images and virtual reality (VR) from various wireless terminal devices, there is a demand for higher communication capacity in the uplink direction and higher transmission signal quality.

The demand for more efficient communication, including higher communication capacity and lower power consumption as described above, is expected to increase further in the next-generation communication systems known as the sixth-generation mobile communication systems (6G) and Beyond 5G.

As a technology to improve communication performance between a wireless terminal device and a base station, a technology has been proposed to receive a user equipment (UE) configuration related to carrier aggregation and NR band processing combinations from a base station and perform communication according to the received UE configuration. Further, a technology has been proposed to multiplex signals to multiple wireless terminal devices into a frame for transmission.

Patent Literature 1: Japanese National Publication of International Patent Application No. 2021-505029.

Patent Literature 2: Japanese Laid-open Patent Publication No. 2018-170797.

However, wireless terminal devices have major constraints, such as the number of antennas mounted and maximum transmission power, which are determined by the size of housings. These constraints of wireless terminal devices are a major bottleneck in uplink communication performance. The constraints such as the number of antennas may be relaxed to improve uplink communication performance. In this case, however, the size of wireless terminal devices is increased. It is unrealistic to increase the size of wireless terminal devices which are desired to be compact and lightweight, so it is difficult to improve uplink communication performance by relaxing the constraints of the wireless terminal devices.

The technology that allows a UE to receive a UE configuration related to carrier aggregation and NR bandwidth processing combinations from a base station and perform communication can improve the efficiency of communication related to a control signal between a wireless terminal device and a base station, but it is difficult to improve the uplink communication performance itself. The technology that multiplexes signals to multiple wireless terminal devices into a frame for transmission is designed to improve transmission efficiency in downlink communications, and it is difficult to improve uplink communication performance.

### SUMMARY

According to an aspect of an embodiment, a base station device includes a plurality of wireless stations. the wireless stations each includes, a receiver that receives signals transmitted from a plurality of wireless terminal devices that transmit transmission data in a coordinated manner, and a controller that selects a reference wireless station from among the wireless stations, determines a phase of the transmission data for each of the wireless terminal devices at the selected reference wireless station, and notifies the wireless terminal devices of the determined phase.

The object and advantages of the disclosure will be realized and attained by means of the elements and combinations particularly pointed out in the claims.

It is to be understood that both the foregoing general description and the following detailed description are exemplary and explanatory and are not restrictive of the disclosure, as claimed.

### BRIEF DESCRIPTION OF DRAWINGS

FIG. 1 is a configuration diagram of a wireless communication system;

FIG. 2 is a diagram illustrating another configuration example of the wireless communication system;

FIG. 3 is a block diagram of a wireless terminal device according to a first embodiment;

FIG. 4 is a block diagram of an RU which is a wireless station;

FIG. 5 is a block diagram for reception quality measurement in a receiving process in the RU;

FIG. 6 is a diagram illustrating separation of reference signals;

FIG. 7 is a diagram illustrating acquisition of a reception signal for each wireless terminal device;

FIG. 8 is a diagram illustrating propagation channel compensation and combining;

FIG. 9 is a diagram illustrating an example of weighting;

FIG. 10 is a sequence diagram of an uplink data transmitting process by the wireless communication system according to the first embodiment;

FIG. 11 is a flowchart of the uplink data transmitting process by the wireless terminal device according to the first embodiment;

FIG. 12 is a flowchart of an uplink data receiving process by the RU according to the first embodiment;

FIG. 13 is a block diagram of the wireless terminal device with a different relay method;

FIG. 14 is a diagram illustrating an example of data distribution according to a second embodiment;

FIG. 15 is a diagram illustrating an example of a hardware configuration of the wireless terminal device; and

FIG. 16 is a diagram illustrating an example of a hardware configuration of the RU.

### DESCRIPTION OF EMBODIMENTS

Preferred embodiments of the present disclosure will be explained with reference to accompanying drawings. The following embodiments are not intended to limit the base station device, the wireless terminal device, the wireless communication system, and the communication control method disclosed in this application.

### (a) First Embodiment

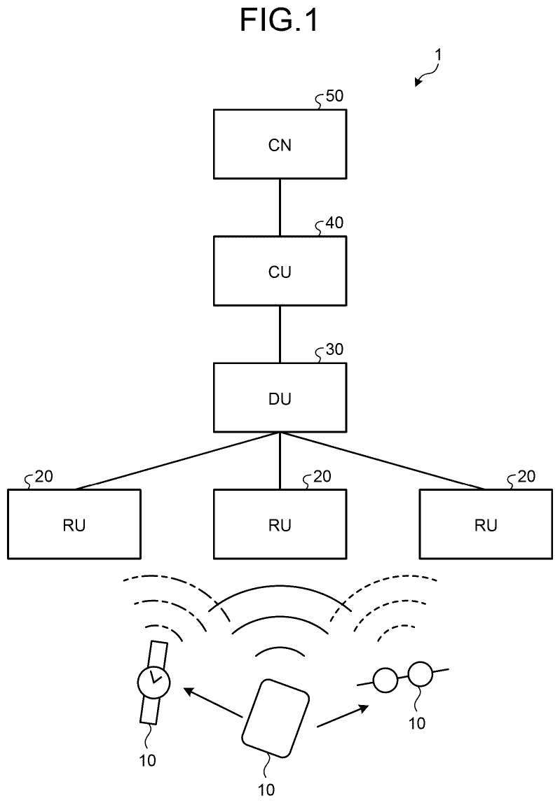

FIG. 1 is a configuration diagram of a wireless communication system. A wireless communication system 1 according to the present embodiment includes a plurality of wireless terminal devices 10 that perform coordinated transmission of transmitting data in a coordinated manner, a plurality of remote units or radio units (RUS) 20, a distributed unit (DU) 30, a central unit (CU) 40, and a core network (CN) 50. The RUs 20, the DU 30, and the CU 40 are a base station device.

The CN 50 is a network located at a level above the base station device.

The DU 30 and the CU 40 serve a baseband function of the base station device. The CU 40 is connected to the CN 50. The CU 40 is also connected to the DU 30. The DU 30 is connected to the RUs 20. The number of the RUs 20 connected to the DU 30 does not need to be two or more and may be one.

More specifically, the DU 30 performs baseband processing at physical and L2 layers. For example, the DU 30 receives uplink data, which is data in the uplink direction transmitted from the wireless terminal devices 10. The DU 30 then performs baseband processing at physical and L2 layers for the received uplink data and transmits the processed data to the CU 40.

The CU 40 performs baseband processing at the L2 layer at a level above the functions assigned to the DU 30. For example, the CU 40 receives, from the DU 30, uplink data subjected to baseband processing at the physical layer and the L2 layer assigned to the DU 30. The CU 40 then performs baseband processing at the L2 layer at a level above the functions assigned to the DU 30 for the received uplink data, and transmits the processed data to the CN 50.

Here, in FIG. 1, the DU 30 and the CU 40 are illustrated as separate devices, but the DU 30 and the CU 40 do not need to be separated, and both functions may be combined in one device.

The RUs 20 each are a wireless station of the base station device. The RU 20 is connected to DU 30. The RU 20 receives reference signals transmitted in a coordinated manner from the wireless terminal devices 10. The RU 20 then selects an appropriate weight for each of the reference signals transmitted from the wireless terminal devices 10 and combines the weighted reference signals to generate a combined signal. Here, the weight has an amplitude and a phase according to a reception result of each of the signals transmitted from the wireless terminal devices 10. The weight is preferably set so that the quality of the reception signal after combining is as good as possible. The RU 20 then measures the reception quality of the generated combined signal.

Each RU 20 then transmits the reception quality measurement result to a specific RU 20 that is predetermined as a device that selects an RU 20 serving as a reference for data transmission in coordinated transmission. The specific RU 20 compares the reception quality measurement result from each RU 20 and determines the RU 20 with the best reception quality as the RU 20 serving as a reference. Instead of the specific RU 20, the DU 30 or the CU 40 may determine an RU 20 to which the reception quality measurement result is transmitted and which compares the measurement results and determines the RU 20 serving as a reference. In the following, the RU 20 that serves as a reference for data transmission in coordinated transmission is referred to as “reference wireless station”. The RU 20 selected as the reference wireless station then determines the phase settings of transmission data in the wireless terminal devices 10 so that the best reception quality is achieved. The RU 20 selected as the reference wireless station then transmits and makes notifications of the respective phase settings to the wireless terminal devices 10.

Each RU 20 then receives phase-controlled uplink data with the notified phase setting from each wireless terminal device 10. Each RU 20 then transmits the received uplink data to the DU 30.

In FIG. 1, there are three wireless terminal devices 10. One of the wireless terminal devices 10 is, for example, a smartphone. One of the other wireless terminal devices 10 is, for example, a smartwatch. The remaining wireless terminal device 10 is, for example, a glasses-like communication device. The three wireless terminal devices 10 illustrated in FIG. 1 perform coordinated transmission of transmitting uplink data in a coordinated manner to the RU 20. In other words, a plurality of wireless terminal devices 10 are regarded as MIMO antennas and perform MIMO transmission of uplink data. For example, the wireless terminal device 10 that is a smartphone is a source that generates uplink data and transmits data to be subjected to coordinated transmission in the generated uplink data to the other wireless terminal devices 10. The three wireless terminal devices 10 then transmit the received data as respective uplink data toward the RU 20.

Here, the three wireless terminal devices 10 may transmit the same transmission data, or may transmit different pieces of transmission data into which one piece of transmission data is divided. The transmission of the same transmission data is called MIMO diversity, and the transmission of different pieces of transmission data into which one piece of transmission data is divided is called MIMO multiplexing. In MIMO diversity, the three wireless terminal devices 10 send transmission data in a coordinated manner so that the transmission power of the transmission data in total can be increased. In MIMO multiplexing, the three wireless terminal devices 10 send transmission data in a coordinated manner so that the transmission time for one piece of transmission data can be reduced, or the amount of data transmitted in a given time can be increased, thereby improving the communication speed.

The wireless terminal device 10 transmits a reference signal to each RU 20. The wireless terminal device 10 then receives information on the phase setting during transmission of uplink data for the wireless terminal device 10 itself from the RU 20 serving as a reference wireless station. The wireless terminal device 10 then transmits the uplink data with the notified phase setting toward each RU 20.

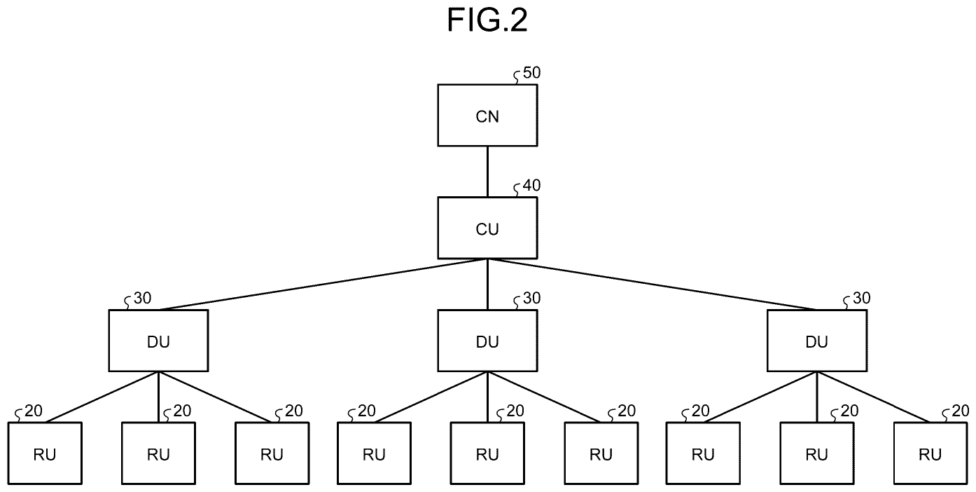

Although a configuration with a one-to-one relationship between the DU 30 and the CU 40 has been described in the present embodiment, the wireless communication system 1 may have other configurations. FIG. 2 is a diagram illustrating another configuration example of the wireless communication system. As illustrated in FIG. 2, a configuration in which a plurality of DUs 30 are connected to one CU 40 and a plurality of RUs 20 are deployed under each of the DUs 30 may be employed. In this case, a combination of RUs 20 from which a reference wireless station is selected is not limited to RUs 20 under the same DU 30, and a reference wireless station may be selected from RUs 20 connected to different DUs 30. Although not illustrated in the drawing, a configuration in which one RU 20 is deployed under one DU 30 in FIG. 2 may be employed.

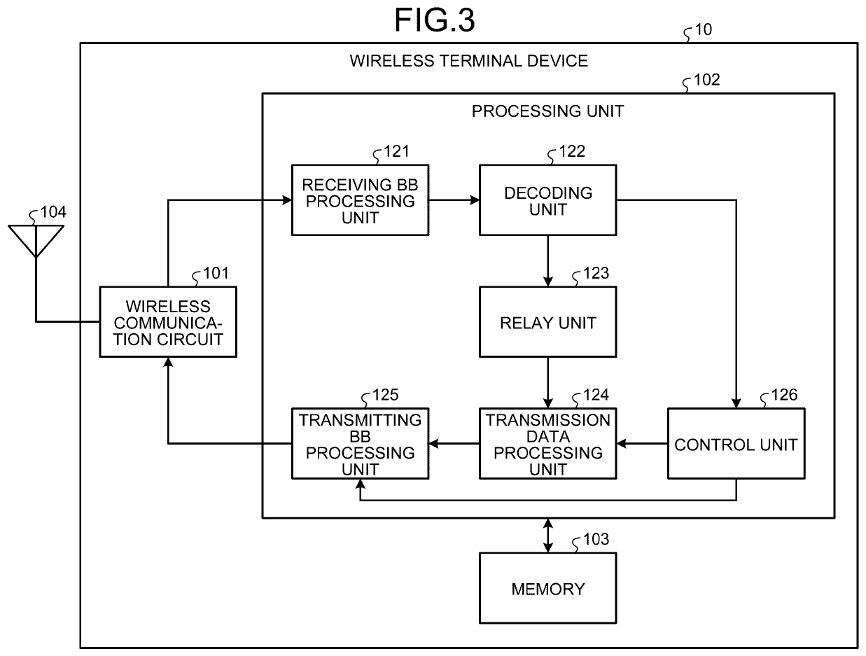

The operation of the RU 20 and the wireless terminal device 10 in transmission of uplink data will now be described in detail below. FIG. 3 is a block diagram of the wireless terminal device according to the first embodiment. The wireless terminal device 10 illustrated in FIG. 3 can transfer data transmitted from other wireless terminal devices 10 to the RU 20 when transmitting uplink data in a coordinated manner with other wireless terminal devices 10. As a relay technique used in this process, the wireless terminal device 10 illustrated in FIG. 3 uses a technique called decode and forward (DF), which encodes the decoded data and transmits the encoded data from an antenna 104. Referring to FIG. 3, the wireless terminal device 10 will be described.

The wireless terminal device 10 includes a wireless communication circuit 101, a processing unit 102, a memory 103, and an antenna 104.

The wireless communication circuit 101 receives a wireless signal transmitted from the RU 20 via the antenna 104. The wireless communication circuit 101 then converts the received wireless signal into a baseband signal by performing processing such as down-conversion (frequency conversion) and analog/digital (A/D) conversion. The wireless communication circuit 101 then outputs the baseband signal to the processing unit 102.

The wireless communication circuit 101 also receives input of a baseband signal from the processing unit 102. Next, the wireless communication circuit 101 converts the acquired baseband signal into a wireless signal by performing processing such as D/A conversion and up-conversion (frequency conversion). The wireless communication circuit 101 then transmits the wireless signal to the RU 20 via the antenna 104.

The memory 103 temporarily stores data when the processing unit 102 performs various processing for a baseband signal.

The processing unit 102 performs processing for a baseband signal. As illustrated in FIG. 3, the processing unit 102 includes a receiving BB (Base Band) processing unit 121, a decoding unit 122, a relay unit 123, a transmission data processing unit 124, and a transmitting BB processing unit 125.

The receiving BB processing unit 121 acquires a baseband signal input from the wireless communication circuit 101. The receiving BB processing unit 121 then converts the acquired baseband signal into soft decision information before decoding by performing processing such as channel estimation, channel compensation, and demodulation. The receiving BB processing unit 121 then outputs the processed baseband signal to the decoding unit 122.

The decoding unit 122 receives input of a baseband signal converted to soft decision information from the receiving BB processing unit 121. The decoding unit 122 then performs error correction decoding such as Viterbi decoding and Turbo decoding for the acquired baseband signal. The decoding method here corresponds to the encoding method performed at the transmission side, and is not limited to the above examples. In data transmission, the decoding unit 122 then passes the decoded data to an application (not illustrated) or the like that performs processing at an upper layer. For example, the application provides the user the acquired data displayed on a screen. In signal relay in coordinated transmission, the decoding unit 122 outputs the decoded data to the relay unit 123.

When data is control information that notifies the phase of uplink data, the decoding unit 122 outputs the decoded data to a control unit 126.

The relay unit 123 operates in the signal relay in coordinated transmission. The relay unit 123 acquires decoded data from the decoding unit 122. The relay unit 123 then transfers the acquired data to the transmission data processing unit 124.

The control unit 126 instructs the transmission data processing unit 124 to transmit a reference signal when communication is performed. The control unit 126 then receives, from the decoding unit 122, input of a control signal for notification of the phase of uplink data. The control unit 126 then notifies the transmitting BB processing unit 125 of the phase of uplink data specified by the control signal.

The transmission data processing unit 124 receives an instruction from the control unit 126 to transmit a reference signal at the start of communication. The transmission data processing unit 124 then generates a reference signal and outputs the reference signal to the transmitting BB processing unit 125.

In data transmission, the transmission data processing unit 124 receives input of data to be transmitted from, for example, the application that performs processing at an upper layer. In signal relay in coordinated transmission, the transmission data processing unit 124 receives input of data from the relay unit 123. The transmission data processing unit 124 then performs processing such as encoding for the acquired data. The transmission data processing unit 124 then outputs the encoded data to the transmitting BB processing unit 125.

The transmitting BB processing unit 125 receives input of a reference signal generated at the start of communication from the transmission data processing unit 124. The transmitting BB processing unit 125 then performs modulation and mapping to time and frequency resources for the reference signal. The transmitting BB processing unit 125 then outputs the processed reference signal to the wireless communication circuit 101.

The transmitting BB processing unit 125 receives input of encoded data from the transmission data processing unit 124. The transmitting BB processing unit 125 then performs modulation and mapping to time and frequency resources for the acquired data. The transmitting BB processing unit 125 then outputs the processed data to the wireless communication circuit 101.

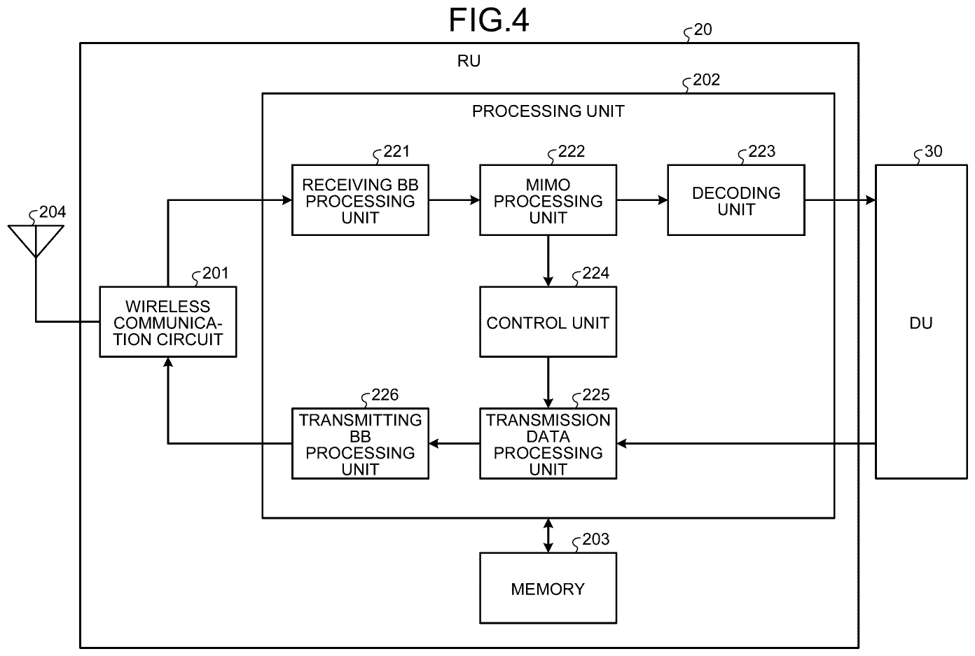

FIG. 4 is a block diagram of the RU, which is a wireless station. Referring now to FIG. 4, the RU 20 will be described. As illustrated in FIG. 4, the RU 20 includes a wireless communication circuit 201, a processing unit 202, a memory 203, and an antenna 204.

The wireless communication circuit 201 receives a wireless signal transmitted from the wireless terminal device 10 via the antenna 204. The wireless communication circuit 201 then converts the received wireless signal into a baseband signal by performing processing such as down-conversion (frequency conversion) and A/D conversion. The wireless communication circuit 201 then outputs the baseband signal to the processing unit 202.

The wireless communication circuit 201 also receives input of a baseband signal received from the DU 30 from the processing unit 202. Next, the wireless communication circuit 201 converts the acquired baseband signal into a wireless signal by performing processing such as D/A conversion and up-conversion (frequency conversion). The wireless communication circuit 201 then transmits the wireless signal to the wireless terminal device 10 via the antenna 204.

The memory 203 temporarily stores data when the processing unit 202 performs various processing for a baseband signal.

The processing unit 202 performs processing for a baseband signal. The processing unit 202 also performs addition of candidate weights and combining for reference signals, and determination of a weight that provides the best quality. As illustrated in FIG. 4, the processing unit 202 includes a receiving BB processing unit 221, a MIMO processing unit 222, a decoding unit 223, a control unit 224, a transmission data processing unit 225, and a transmitting BB processing unit 226.

The receiving BB processing unit 221 acquires a baseband signal input from the wireless communication circuit 201. The receiving BB processing unit 221 then performs processing such as channel estimation and channel compensation. Here, the receiving BB processing unit 221 has a plurality of candidate weights to be added to each wireless terminal device 10. In the case of a reference signal, the receiving BB processing unit 221 selects an appropriate weight for each wireless terminal device 10 according to the received reference signal and the MIMO scheme and adds the weight to the reference signal to perform channel compensation. The receiving BB processing unit 221 then outputs the processed baseband signal to the MIMO processing unit 222.

The MIMO processing unit 222 receives input of baseband signals from the receiving BB processing unit 221. The MIMO processing unit 222 then performs MIMO reception processing for the acquired baseband signals and combines the baseband signals to generate a combined signal. Further, the MIMO processing unit 222 converts the baseband signal, which is a combined signal, into soft decision information before decoding by performing demodulation and the like.

In the case of uplink data transmitted from the wireless terminal device 10, the MIMO processing unit 222 then outputs the baseband signal, which is a combined signal, subjected to the MIMO reception processing, to the decoding unit 223. In the case of a reference signal, the MIMO processing unit 222 outputs the baseband signal, which is a combined signal that combines the reference signals transmitted from the wireless terminal devices 10, to the control unit 224.

The receiving BB processing unit 221 and the MIMO processing unit 222 described above are an example of “receiving unit”. In other words, the receiving BB processing unit 221 and the MIMO processing unit 222 receive signals transmitted from a plurality of wireless terminal devices 10 that transmit transmission data in a coordinated manner.

The decoding unit 223 receives input of a baseband signal subjected to the MIMO reception processing from the MIMO processing unit 222. The decoding unit 223 then performs error correction decoding. The decoding unit 223 then transmits the decoded baseband signal to the DU 30.

The control unit 224 receives input of a combined signal that combines the reference signals transmitted from the wireless terminal devices 10, from the MIMO processing unit 222.

Next, the control unit 224 measures the reception quality of the acquired combined signal. Specifically, the control unit 224 measures the reception quality by calculating the signal-to-noise (SN) ratio of the received baseband signal and the transmission capacity that can be accommodated between the wireless terminal device 10 and the RU 20.

If the RU 20 is not a specific RU 20 predetermined as a device that selects a reference wireless station, the control unit 224 transmits the reception quality measurement result to the specific RU 20. In this case, for example, if there is a network for communication between RUs 20, the control unit 224 uses the network to transmit information to the other RUs 20. Otherwise, the control unit 224 may transmit information to the other RUs 20 via the DU 30.

On the other hand, if the RU 20 is a specific RU 20, the control unit 224 acquires the reception quality measurement results transmitted from the other RUs 20. The control unit 224 then compares the reception quality transmitted from the RUs 20 and selects the RU 20 with the best reception quality among them as a reference wireless station. The control unit 224 then notifies the selected RU 20 that it is a reference wireless station.

In the present embodiment, the other RUs 20 transmit the reception quality measurement results to the specific RU 20, and the specific RU 20 selects a reference wireless station, but the method of selecting a reference wireless station is not limited to this. For example, all RUs 20 may acquire the reception quality measurement result from each RU 20 and individually select a reference wireless station. In this method, all RUs 20 can select the same reference wireless station, since the reception quality measurement results used in each RU 20 are the same. In this case, notification of the reference wireless station does not need to be performed, since the RU 20 selected as a reference wireless station can confirm that the selected RU 20 itself is a reference wireless station.

The control unit 224 in the RU 20 selected as a reference wireless station receives notification from the specific RU 20 that it is a reference wireless station. The control unit 224 then determines the phase setting for each wireless terminal device 10 so as to achieve the best reception quality of uplink data transmitted from each wireless terminal device 10 in a coordinated manner. For example, the control unit 224 may determine the phase setting for each wireless terminal device 10 from the weight selected from among candidate weights by the receiving BB processing unit 221 as the optimal weight. The control unit 224 then instructs the transmission data processing unit 225 to transmit control information to notify the wireless terminal devices 10 of the phase setting determined for each wireless terminal device 10.

Here, in the present embodiment, the RU 20 serving as a reference wireless station transmits the phase setting of uplink data for each wireless terminal device 10, but the notification method of the phase setting is not limited to this. For example, another RU 20, such as a specific RU 20, may acquire information on the phase setting at the RU 20 selected as a reference wireless station and notify each wireless terminal device 10.

In downlink data transmission, the transmission data processing unit 225 receives data to be transmitted from the DU 30. The transmission data processing unit 225 receives an instruction from the control unit 224 to transmit control information to notify the wireless terminal devices 10 of the phase setting determined for each wireless terminal device 10.

The transmission data processing unit 225 then performs processing such as encoding for the received data. The transmission data processing unit 225 then outputs the encoded baseband signal to the transmitting BB processing unit 226.

The transmitting BB processing unit 226 receives input of the encoded baseband signal from the transmission data processing unit 225. The transmitting BB processing unit 226 then performs processing such as modulation and mapping to time and frequency resources for the received baseband signal. The transmitting BB processing unit 226 then outputs the processed baseband signal to the wireless communication circuit 201.

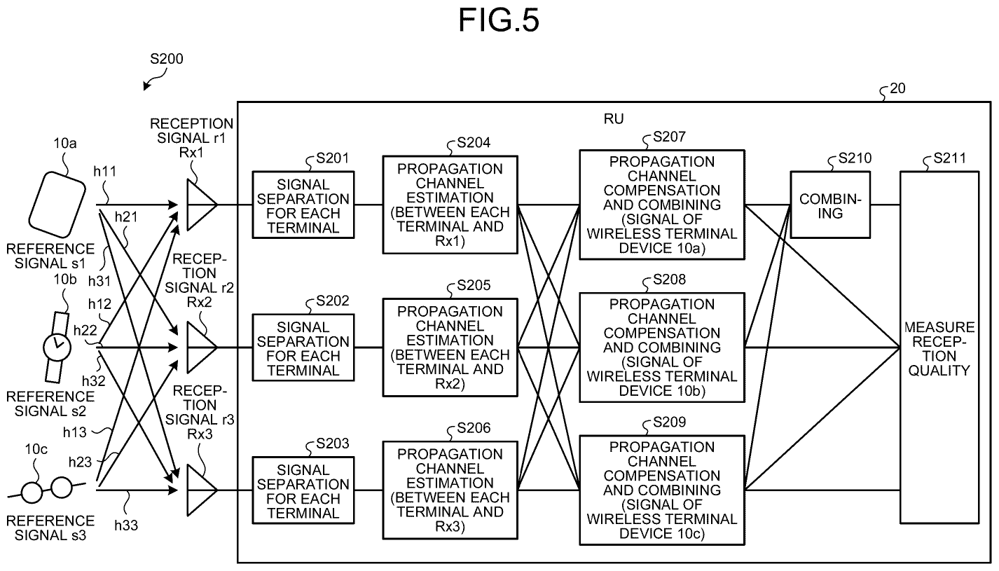

The process of receiving a reference signal by the RU 20 will now be described more specifically. FIG. 5 is a block diagram for reception quality measurement in the receiving process in the RU. Here, there are three wireless terminal devices 10, namely, wireless terminal devices 10a to 10c, each having one antenna 104. The RU 20 has three receiving antennas Rx1 to Rx3 for reception as the antenna 204. However, the numbers of antennas 104 and 204 are examples and are not limited to these.

The wireless terminal devices 10a to 10c each transmit a reference signal toward the receiving antennas Rx1 to Rx3 of the RU 20 (step S200).

The reference signals for uplink data transmitted by the wireless terminal devices 10a to 10c are denoted as reference signals s1 to s3, respectively, and the signals received by the receiving antennas Rx1 to Rx3 of the RU 20 are denoted as reception signals r1 to r3, respectively.

Here, a propagation channel matrix (H), which represents propagation channel characteristics, is expressed by the following equation (1).

$$Propagation channel matrix H = [ \begin{matrix}{h}_{11} & {h}_{12} & {h}_{13} \\ {h}_{21} & {h}_{22} & {h}_{23} \\ {h}_{31} & {h}_{32} & {h}_{33}\end{matrix} ] \qquad ( 1 )$$

The first argument (x) of each component (hxy) in the propagation channel matrix (H) represents the number of each of the receiving antennas Rx1 to Rx3, and the second argument (y) represents the number of the transmitting antenna. Here, the number of the receiving antenna is the last number of each of the receiving antennas Rx1 to Rx3. The number of the transmitting antenna is a number where the antenna 104 of the wireless terminal device 10a is 1, the antenna 104 of the wireless terminal device 10b is 2, and the antenna 104 of the wireless terminal device 10c is 3. For example, h13 is a complex number that represents the phase and magnitude change that a signal undergoes when a radio wave propagates from the antenna 104 of the wireless terminal device 10c to the receiving antenna Rx1. In other words, the propagation channels between the wireless terminal devices 10a to 10c and the receiving antennas Rx1 to Rx3 have h11 to h33 as propagation channel states, as illustrated in FIG. 5.

In this case, the reception signals r1 to r3 are expressed by the following equation (2). Here, n1 to n3 represent noise.

$$[ \begin{matrix}{r}_{1} \\ {r}_{2} \\ {r}_{3}\end{matrix} ] = [ \begin{matrix}{h}_{11} & {h}_{12} & {h}_{13} \\ {h}_{21} & {h}_{22} & {h}_{23} \\ {h}_{31} & {h}_{32} & {h}_{33}\end{matrix} ] [ \begin{matrix}{s}_{1} \\ {s}_{2} \\ {s}_{3}\end{matrix} ] + [ \begin{matrix}{n}_{1} \\ {n}_{2} \\ {n}_{3}\end{matrix} ] \qquad ( 2 )$$

In other words, the reception signals received by the receiving antennas Rx1 to Rx3 are expressed by the following equations (3).

$$\begin{matrix}{r}_{1} = {h}_{11} {s}_{1} + {h}_{12} {s}_{2} + {h}_{13} {s}_{3} + {n}_{1} \\ {r}_{2} = {h}_{21} {s}_{1} + {h}_{22} {s}_{2} + {h}_{23} {s}_{3} + {n}_{2} \\ {r}_{3} = {h}_{31} {s}_{1} + {h}_{32} {s}_{2} + {h}_{33} {s}_{3} + {n}_{3}\end{matrix} \qquad ( 3 )$$

Next, the RU 20 performs signal separation for each of the wireless terminal devices 10a to 10c for the signal received at the receiving antenna Rx1 (step S201). The RU 20 also performs signal separation for each of the wireless terminal devices 10a to 10c for the signal received at the receiving antenna Rx2 (step S202). The RU 20 also performs signal separation for each of the wireless terminal devices 10a to 10c for the signal received at the receiving antenna Rx3 (step S203). For example, the receiving BB processing unit 221 performs the processing at steps S201 to S203.

The reference signals s1 to s3 are respectively transmitted by the wireless terminal devices 10a to 10c using different time components, different frequency components, or different signal sequence patterns, or a combination of these methods. The RU 20 on the receiving side therefore can separate the reference signals s1 to s3 respectively sent from the wireless terminal devices 10a to 10c.

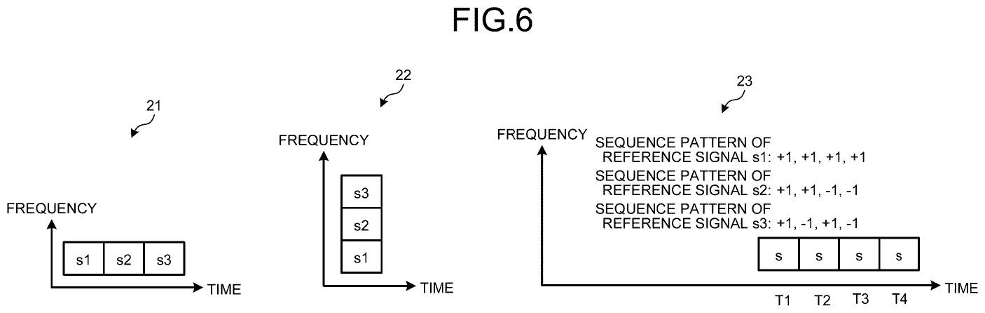

FIG. 6 is a diagram illustrating separation of reference signals. Graphs 21 to 23 in FIG. 6 represent passage of time on the horizontal axis and represent frequency on the vertical axis. Graph 21 illustrates an example in which the reference signals s1 to s3 are transmitted using different time components. Graph 22 illustrates an example in which the reference signals s1 to s3 are transmitted using different frequency components. Graph 23 illustrates an example in which the reference signals s1 to s3 are transmitted using different signal sequence patterns. In graph 23, the wireless terminal devices 10a to 10c transmit the reference signals s1 to s3 using common time and frequency components.

When the wireless terminal devices 10a to 10c transmit the respective reference signals s1 to s3 using different time components as illustrated in graph 21, the RU 20 can separate and extract the respective reference signals s1 to s3 of the wireless terminal devices 10a to 10c by extracting the respective time components.

When the wireless terminal devices 10a to 10c transmit the respective reference signals s1 to s3 using different frequency components as illustrated in graph 22, the RU 20 can separate and extract the respective reference signals s1 to s3 of the wireless terminal devices 10a to 10c by extracting the respective frequency components.

In graph 23, the wireless terminal devices 10a to 10c respectively transmit the reference signals s1 to s3 using the respective signal sequence patterns of the reference signals s1 to s3 illustrated in graph 23. The respective reference signals s1 to s3 are transmitted at values corresponding to time T1 to T4 illustrated in graph 23. In this case, the RU 20 can extract a reference signal by removing or reducing components of the other wireless terminal devices 10a to 10c by multiplying the complex conjugate of the signal sequence for each of the wireless terminal devices 10a to 10c and then adding the results of multiplication.

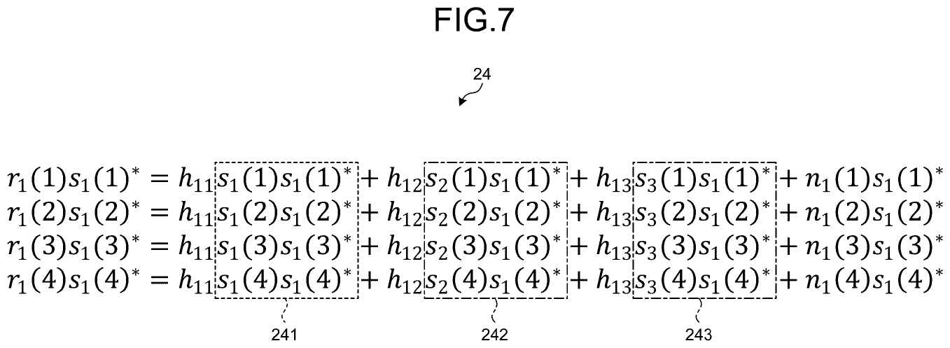

For example, the signal separation for the case illustrated in graph 23 will be described in more detail. When a reference signal from the wireless terminal device 10a that arrives at the receiving antenna Rx1 is extracted, the RU 20 performs the following processing. The RU 20 obtains Expression 24 illustrated in FIG. 7 by multiplying the reception signals including the reference signals s1 to s3 by the complex conjugate of the signal sequence pattern of the reference signal s1 of the wireless terminal device 10a, at each of times T1 to T4. FIG. 7 is a diagram illustrating acquisition of a reception signal for each wireless terminal device. In Expression 24, “si(t)*” represents the complex conjugate of “si(t)”.

The RU 20 then adds up the equations in Expression 24. In this case, in a component 241 in the first terms of the equations, the reference signals s1 of the wireless terminal device 10a are added in phase, leaving a component (h11) of the propagation channel characteristics. In this case, however, the RU 20 assumes that nearby propagation channel variations are negligibly small in the time and frequency domains, as illustrated in graph 23.

In a component 242 in the second terms of the equations, when the signal sequence patterns of the reference signal s2 and the reference signal s1 are orthogonal, the components of the reference signal s2 from the wireless terminal device 10b are removed by calculating the sum. The components 243 of the reference signal s3 from the wireless terminal device 10c in the third terms are removed in the same way. The noise components in the fourth terms are added randomly and remain as noise.

In this case, the RU 20 calculates the following equation (4) as a result of extracting the reference signal s1 from the wireless terminal device 10a received at the receiving antenna Rx1.

$${r}_{1 , MS 1} = {\sum }_{t} {h}_{11} {s}_{1} ( t ) {{s}_{1} ( t )}^{*} + {\sum }_{t} {n}_{1} ( t ) {{s}_{1} ( t )}^{*} \qquad ( 4 )$$

Similarly, the RU 20 calculates the following equations (5) and (6) as a result of extracting the reference signal s1 from the wireless terminal device 10a received at the receiving antennas Rx2 and Rx3.

$${r}_{2 , MS 1} = {\sum }_{t} {h}_{21} {s}_{1} ( t ) {{s}_{1} ( t )}^{*} + {\sum }_{t} {n}_{2} ( t ) {{s}_{1} ( t )}^{*} \qquad ( 5 )$$

$${r}_{3 , MS 1} = {\sum }_{t} {h}_{31} {s}_{1} ( t ) {{s}_{1} ( t )}^{*} + {\sum }_{t} {n}_{3} ( t ) {{s}_{1} ( t )}^{*} \qquad ( 6 )$$

The RU 20 performs the same calculation for all combinations of the receiving antennas Rx1 to Rx3 and the wireless terminal devices 10a to 10c. The RU 20 then estimates the respective propagation channel states (h11 to h33), from the reference signals s1 to s3 received at the receiving antennas Rx1 to Rx3 (steps S204 to S206). For example, the receiving BB processing unit 221 performs the processing at steps S204 to S206.

Next, the RU 20 combines the reference signals s1 to s3 obtained at the receiving antennas Rx1 to Rx3, for each of the wireless terminal devices 10a to 10c, after weighting with the complex conjugate of the propagation channel state. In this way, the RU 20 can generate a combined signal as a reception signal after combining by maximum ratio combining. For example, the receiving BB processing unit 221 performs a weighting process, and the MIMO processing unit 222 performs a combining process.

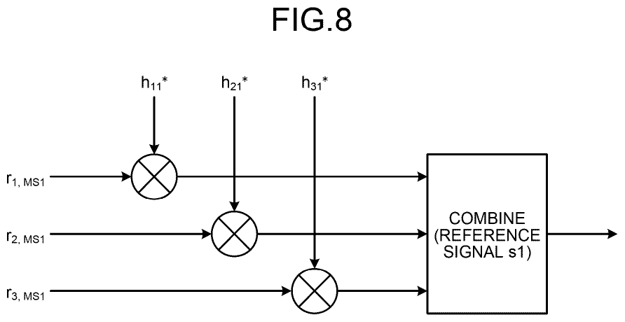

FIG. 8 is diagram illustrating propagation channel compensation and combining. For example, the RU 20 performs propagation channel compensation by the following processing for a signal r_{1,MS1}, which is the reference signal s1 received at the receiving antenna Rx1, obtained by signal separation using equations (4) to (6). The RU 20 weights the signal r_{1,MS1} with the complex conjugate of the state h11 of the propagation channel between the wireless terminal device 10a and the receiving antenna Rx1. Similarly, the RU 20 weights a signal r_{2,MS1}, which is the reference signal s1 received at the receiving antenna Rx1, with the complex conjugate of the state h21 of the propagation channel between the wireless terminal device 10a and the receiving antenna Rx2. Further, the RU 20 weights a signal r_{3,MS1}, which is the reference signal s1 received at the receiving antenna Rx3, with the complex conjugate of the state h31 of the propagation channel between the wireless terminal device 10a and the receiving antenna Rx3. The RU 20 then combines the signals r_{1,MS1} to r_{3,MS1} subjected to propagation channel compensation to acquire the reference signal s1 from the wireless terminal device 10a (step S207).

Similarly, the RU 20 acquires the reference signal s2 from the wireless terminal device 10b (step S208). Further, the RU 20 acquires the reference signal s3 from the wireless terminal device 10c (step S209).

Next, in MIMO diversity in which the wireless terminal devices 10a to 10c transmit the same data, the RU 20 combines the reception signals from the wireless terminal devices 10a to 10c by adding them together to acquire the reference signals s1 to s3 after diversity combining (step S210).

On the other hand, in MIMO multiplexing in which one piece of data is divided and the wireless terminal devices 10a to 10c transmit different divided data, the RU 20 regards the respective signals of the wireless terminal devices 10a to 10c as the reference signals s1 to s3.

The RU 20 then measures the reception quality according to the MIMO scheme by obtaining the reception quality of the respective reference signals s1 to s3 of the wireless terminal devices 10a to 10c or the reference signals s1 to s3 after combining (step S211). For example, the control unit 224 executes the processing at step S211.

For example, in MIMO multiplexing, the RU 20 can measure the SN ratio from the average of a plurality of reference signals s1 to s3 in time and frequency directions and their dispersion (variance) in the respective signals of the wireless terminal devices 10a to 10c. In MIMO diversity, the RU 20 can measure the SN ratio by determining the average and the dispersion (variance) of the combined signal after the reference signals s1 to s3 from the wireless terminal devices 10a to 10c are combined.

As described above, the RU 20 can perform extraction and quality measurement of a reception signal by determining the propagation channel characteristics between the RU 20 and each wireless terminal device 10 using a reference signal on the receiving side, performing compensation using the propagation channel characteristics, and then combining the same signal after compensation.

Although the reception of reference signals has been described above, the RU 20 can also obtain reception signals by performing the same processing for uplink data. In other words, the RU 20 acquires a reception signal after combining by maximum ratio combining, by combining the respective reception signals r1 to r3 at the receiving antennas Rx1 to Rx3 after weighting with the complex conjugates of the respective propagation channel states.

For example, a case where the signal components of the wireless terminal devices 10a to 10c are s01 to s03, and the propagation channel matrix (H) is represented by equation (1) will be described. In this case, the RU 20 calculates the following equation (7) by weighting and combining the reception signals r1 to r3 with the complex conjugates of the propagation channel states h11, h21, and h31.

$${r}_{MS 1} = {h}_{11} * ( {h}_{11} {s}_{01} + {h}_{12} {s}_{02} + {h}_{13} {s}_{03} + {n}_{1} ) + {h}_{21} * ( {h}_{21} {s}_{01} + {h}_{22} {s}_{02} + {h}_{23} {s}_{03} + {n}_{2} ) + {h}_{31} * ( {h}_{31} {s}_{01} + {h}_{32} {s}_{02} + {h}_{33} {s}_{03} + {n}_{3} ) \qquad ( 7 )$$

In equation (7), the coefficients for the signal components s02 and s03 of the wireless terminal devices 10b and 10c cancel each other because the phases are random, and the residual components become interference, resulting in a reception signal after combining from the wireless terminal device 10a.

Similarly, the RU 20 can obtain a reception signal after combining from the wireless terminal device 10b and a reception signal after combining from the wireless terminal device 10c, as expressed by the following equations (8) and (9).

$${r}_{MS 2} = {h}_{12} * ( {h}_{11} {s}_{01} + {h}_{12} {s}_{02} + {h}_{13} {s}_{03} + {n}_{1} ) + {h}_{22} * ( {h}_{21} {s}_{01} + {h}_{22} {s}_{02} + {h}_{23} {s}_{03} + {n}_{2} ) + {h}_{32} * ( {h}_{31} {s}_{01} + {h}_{32} {s}_{02} + {h}_{33} {s}_{03} + {n}_{3} ) \qquad ( 8 )$$

$${r}_{MS 3} = {h}_{13} * ( {h}_{11} {s}_{01} + {h}_{12} {s}_{02} + {h}_{13} {s}_{03} + {n}_{1} ) + {h}_{23} * ( {h}_{21} {s}_{01} + {h}_{22} {s}_{02} + {h}_{23} {s}_{03} + {n}_{2} ) + {h}_{33} * ( {h}_{31} {s}_{01} + {h}_{32} {s}_{02} + {h}_{33} {s}_{03} + {n}_{3} ) \qquad ( 9 )$$

The weighting of the reference signal by the RU 20 will now be described. The RU 20 has several candidate weights as a weight for each wireless terminal device 10 at the transmission side. The RU 20 then selects the optimal weight from the candidate weights according to the MIMO scheme.

For example, in MIMO diversity, the RU 20 employs, as the weight of each wireless terminal device 10, such a weight that the signals transmitted from the wireless terminal devices 10 on the transmission side are in-phase as much as possible, that is, enhance each other, at the antenna 204 of the RU 20. On the other hand, in MIMO multiplexing, the RU 20 employs, as the weight of each wireless terminal device 10, the weight that makes the signals as orthogonal as possible at the antenna 204.

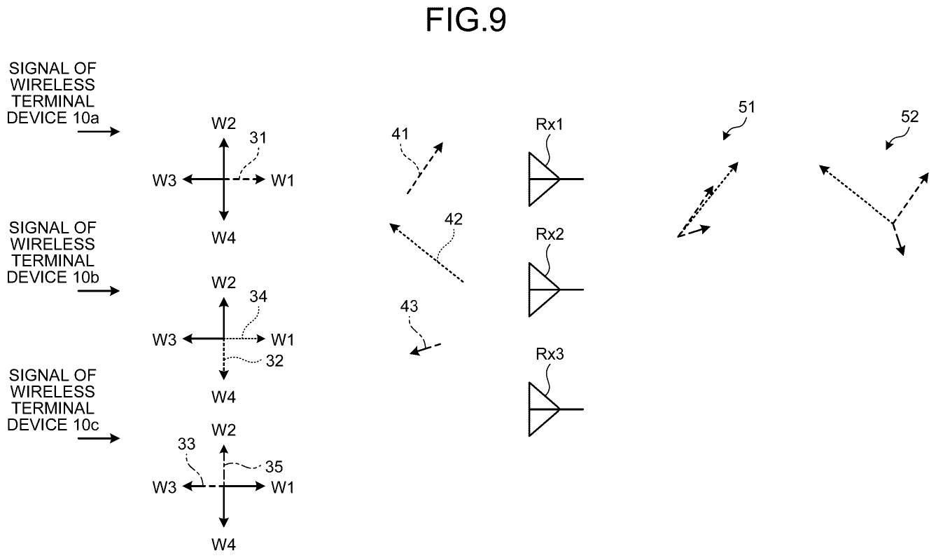

FIG. 9 is diagram illustrating an example of weighting. Referring to FIG. 9, the weighting of signals will be described using a case where there are wireless terminal devices 10a to 10c and there are receiving antennas Rx1 to Rx3.

In FIG. 9, the transmission channels between the wireless terminal devices 10a to 10c and the receiving antenna Rx1 are states 41 to 43. In this case, the RU 20 has weights W1 to W4 as candidate weights. The RU 20 then determines to add the weight W1 represented by arrow 31 to a signal from the wireless terminal device 10a.

In MIMO diversity, the RU 20 weights the respective signals from the wireless terminal devices 10b and 10c so that the signals enhance each other as much as possible. In this case, the RU 20 adds the weight W4 represented by arrow 32 to a signal from the wireless terminal device 10b and adds the weight W3 represented by arrow 33 to a signal from the wireless terminal device 10c. As a result, as indicated by a state 51 representing the weighted signals, the RU 20 can make an adjustment so that the weighted signals enhance each other.

On the other hand, in MIMO multiplexing, the RU 20 weights the respective signals from the wireless terminal devices 10b and 10c so that the signals are orthogonal to each other as much as possible. In this case, the RU 20 adds the weight W1 represented by arrow 34 to a signal from the wireless terminal device 10b and adds the weight W2 represented by arrow 35 to a signal from the wireless terminal device 10c. As a result, as indicated by a state 52 representing the weighted signals, the RU 20 can make an adjustment so that the weighted signals are orthogonal to each other as much as possible. The RU 20 considers the reception states of the receiving antennas Rx2 and Rx3 similarly, and determines the weights that make the best reception quality of the combined signal of the reception signals of the receiving antennas Rx1 to Rx3.

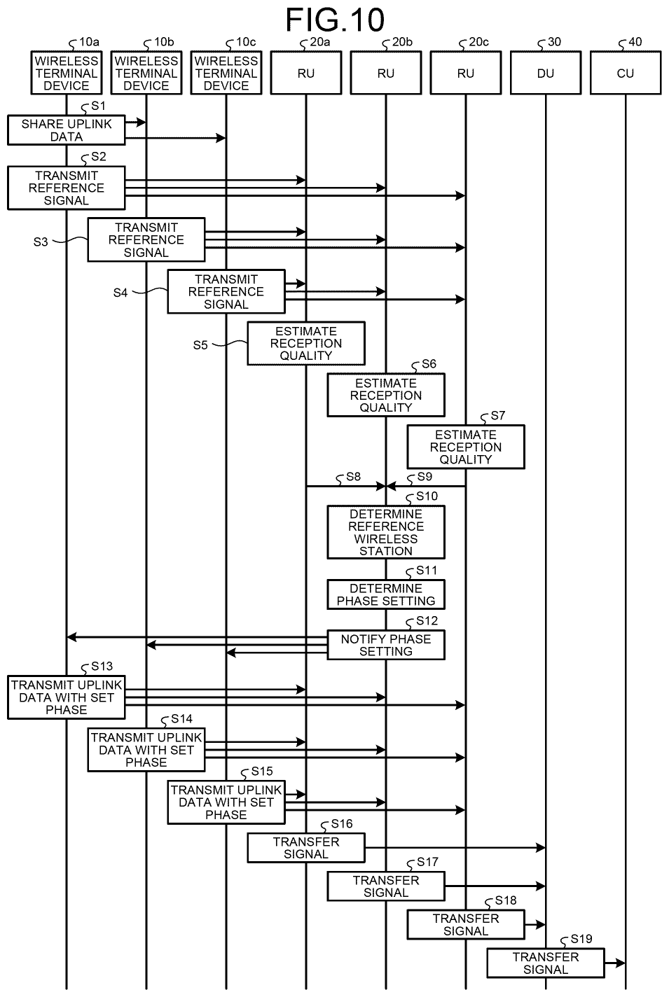

FIG. 10 is a sequence diagram of an uplink data transmitting process by the wireless communication system according to the first embodiment. Referring to FIG. 10, the flow of the uplink data transmitting process by the wireless communication system 1 according to the present embodiment will be described. Here, a case where the wireless terminal devices 10a to 10c perform coordinated transmission of signals to RUs 20a to 20c will be described.

The wireless terminal device 10a transmits uplink data to the wireless terminal devices 10b and 10c to share uplink data (step S1). In this step, in the case of MIMO diversity, the wireless terminal device 10a transmits the same data as its own transmission data to the wireless terminal devices 10b and 10c. In the case of MIMO multiplexing, the wireless terminal device 10a divides transmission data and transmits partial data that does not overlap with data that the wireless terminal device 10a itself transmits, to the wireless terminal devices 10b and 10c in a non-overlapping manner. However, step S1 may be performed between steps S12 and S13. In such a case, the division method (division ratio to each terminal device, type of data, etc.) is also notified at the time of notification of the phase settings from the wireless station RU 20 so that the divided data can be shared according to the notified division method.

Next, the wireless terminal device 10a transmits a reference signal to the RUs 20a to 20c (step S2). The wireless terminal device 10b also transmits a reference signal to the RUs 20a to 20c (step S3). The wireless terminal device 10c also transmits a reference signal to the RUs 20a to 20c (step S4). These reference signals are transmitted, for example, by time multiplexing, frequency multiplexing, or multiplexing using signal sequence patterns.

The RU 20a receives the reference signals, generates a combined signal by weighting and combining, and estimates the reception quality (step S5). Similarly, the RU 20b also receives the reference signals, generates a combined signal by weighting and combining, and estimates the reception quality (step S6). The RU 20c receives the reference signals, generates a combined signal by weighting and combining, and estimates the reception quality (step S7).

Here, it is assumed that the RU 20b is the specific RU 20 that determines a reference wireless station. The RU 20a transmits the reception quality estimation result to the RU 20b (step S8). The RU 20c also transmits the reception quality estimation result to the RU 20b (step S9).

The RU 20b receives the reception quality estimation results from the RUs 20a and 20c. The RU 20b then compares the reception quality estimation results from the RUs 20a to 20c and determines the RU 20 with the best reception quality among the RUs 20a to 20c as a reference wireless station (step S10). Here, a case where the RU 20b is selected as a reference wireless station will be described.

Next, the RU 20b determines the respective phase (or weight having phase and amplitude) settings for the wireless terminal devices 10a to 10c, from the weights added to the wireless terminal devices 10a to 10c (step S11).

Next, the RU 20b notifies the wireless terminal devices 10a to 10c of the respective phase settings (or weight settings) for the wireless terminal devices 10a to 10c (step S12).

The wireless terminal device 10a receives notification of the phase setting from the RU 20b. The wireless terminal device 10a then transmits uplink data with the set phase toward the RUs 20a to 20c (step S13). Similarly, the wireless terminal device 10b also receives notification of the phase setting from the RU 20b. The wireless terminal device 10b then transmits the shared uplink data with the set phase toward the RUs 20a to 20c (step S14). Similarly, the wireless terminal device 10c also receives notification of the phase setting from the RU 20b. The wireless terminal device 10c then transmits the shared uplink data with the set phase toward the RUs 20a to 20c (step S15).

The RU 20a receives the uplink data transmitted from each of the wireless terminal devices 10a to 10c. The RU 20a then generates a baseband signal by performing processing such as decoding, demodulation, and MIMO combining. The RU 20a then transfers the baseband signal to the DU 30 (step S16).

The RU 20b also receives the uplink data transmitted

from each of the wireless terminal devices 10a to 10c. The RU 20b then generates a baseband signal by performing processing such as decoding, demodulation, and MIMO combining. The RU 20b then transfers the baseband signal to the DU 30 (step S17).

The RU 20c also receives the uplink data transmitted from each of the wireless terminal devices 10a to 10c. The RU 20c then generates a baseband signal by performing processing such as decoding, demodulation, and MIMO combining. The RU 20c then transfers the baseband signal to the DU 30 (step S18).

The DU 30 receives the baseband signal from each of the RUs 20a to 20c. The DU 30 then performs baseband processing for the received baseband signal and transfers the processed signal to the CU 40 (step S19). Here, the uplink data transmitted from the wireless terminal devices 10a to 10c may be combined by the DU 30 or the CU 40.

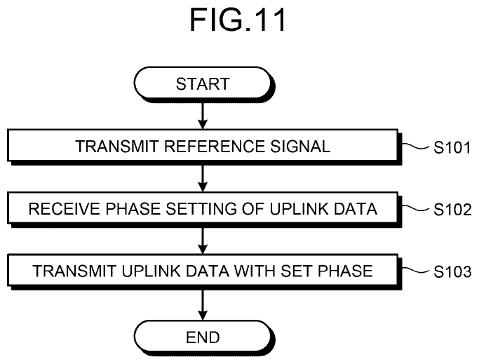

FIG. 11 is a flowchart of an uplink data transmitting process by the wireless terminal device according to the first embodiment. Referring now to FIG. 11, the flow of the uplink data transmitting process by the wireless terminal device 10 according to the first embodiment will be described.

The wireless terminal device 10 shares uplink data with other wireless terminal devices 10 that execute coordinated transmission. The control unit 126 of the wireless terminal device 10 then transmits a reference signal to the RUs 20a to 20c (step S101).

The control unit 126 of the wireless terminal device 10 then receives information on the phase (or weight having phase and amplitude) setting of the uplink data from the RU 20 serving as a reference wireless station (step S102). The control unit 126 then instructs the transmitting BB processing unit 125 to transmit the uplink data with the set phase.

The transmitting BB processing unit 125 of the wireless terminal device 10 then transmits the uplink data with the set phase toward the RU 20 (step S103).

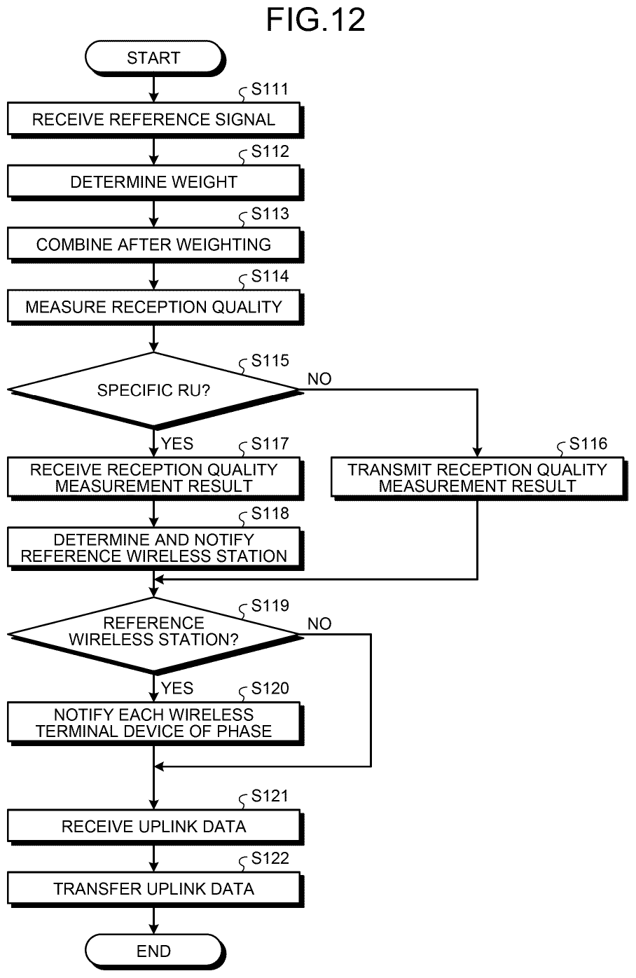

FIG. 12 is a flowchart of an uplink data receiving process by the RU according to the first embodiment. Referring now to FIG. 12, the flow of the uplink data receiving process by the RU 20 according to the first embodiment will be described.

The receiving BB processing unit 221 receives a reference signal converted into a baseband signal (step S111).

The receiving BB processing unit 221 then performs channel estimation for the reference signal and determines an appropriate weight for each wireless terminal device 10 from the candidate weights (step S112).

Next, the receiving BB processing unit 221 performs channel compensation by adding the weight to the reference signal for each wireless terminal device 10. Next, the receiving BB processing unit 221 outputs the reference signal subjected to channel estimation and channel compensation to the MIMO processing unit 222. The MIMO processing unit 222 combines the reference signals received from the receiving BB processing unit 221 to acquire a reception signal (step S113). The MIMO processing unit 222 then outputs the reception signal to the control unit 224.

The control unit 224 measures the reception quality of the reception signal received from the MIMO processing unit 222 (step S114).

Next, the control unit 224 determines whether the RU 20 is a specific RU 20 that selects a reference wireless station (step S115).

If the RU 20 is not a specific RU 20 (No at step S115), the control unit 224 transmits the reception quality measurement result to a specific RU 20 (step S116).

On the other hand, if the RU 20 is a specific RU 20 (Yes at step S115), the control unit 224 receives the reception quality measurement results in the other RUs 20 (step S117).

Next, the control unit 224 compares the reception quality measurement results of the RUs 20 and selects an RU 20 with the best reception quality as a reference wireless station. The control unit 224 then notifies the selected RU 20 that it is a reference wireless station (step S118).

The control unit 224 then determines whether the RU 20 has been selected as a reference wireless station (step S119).

If the RU 20 is not a reference wireless station (No at step S119), the uplink data receiving process proceeds to step S121.

On the other hand, if the RU 20 is a reference wireless station (Yes at step S119), the control unit 224 sets the phase (or weight having phase and amplitude) of the uplink data for each of the wireless terminal devices 10, from the weight added for each wireless terminal device 10. The control unit 224 then instructs the transmission data processing unit 225 to make a notification of the phase set for each wireless terminal device 10. The transmission data processing unit 225 makes the notification of the phase set for each wireless terminal device 10 (step S120).

The MIMO processing unit 222 then receives the uplink data transmitted with the set phase via the antenna 204, the wireless communication circuit 201, and the receiving BB processing unit 221 (step S121). The MIMO processing unit 222 then performs MIMO reception processing for the received uplink data and outputs the processed data to the decoding unit 223.

The decoding unit 223 decodes the uplink data and transfers the decoded data to the DU 30 (step S122).

As described above, the RU according to the present embodiment generates a reception signal by adding an appropriate weight to the reference signal from each wireless terminal device, measures the reception quality of the generated reception signal, and selects the RU with the best reception quality among a plurality of RUs as a reference wireless station. In addition, the RU selected as a reference wireless station determines the phase setting of uplink data in each wireless terminal device from the weight added to each reference signal, and notifies the wireless terminal device of the set phase. The wireless terminal device transmits the uplink data with the notified phase toward the RUs.

With this configuration, the wireless terminal devices that perform coordinated transmission can improve the reception quality of uplink data at the RU by adjusting the respective phases of the uplink data as appropriate to perform MIMO transmission. Since the RU with the high reception quality is selected as a reference wireless station from among a plurality of RUs, the reception quality of uplink data transmitted in a coordinated manner is improved. This configuration provides MIMO effects such as improved transmission capacity or reduced transmission power. In addition, the transmission rate can be improved. Accordingly, uplink communication performance can be improved.

### Modifications

In the first embodiment, the wireless terminal device 10 that relays data by DF when transmitting data received from the other wireless terminal devices 10 in a coordinated manner to the RU 20 has been described as an example. However, the embodiment is not limited to this, and the wireless communication system 1 according to an embodiment can improve uplink communication performance similarly even when the wireless terminal device 10 employs other relay methods.

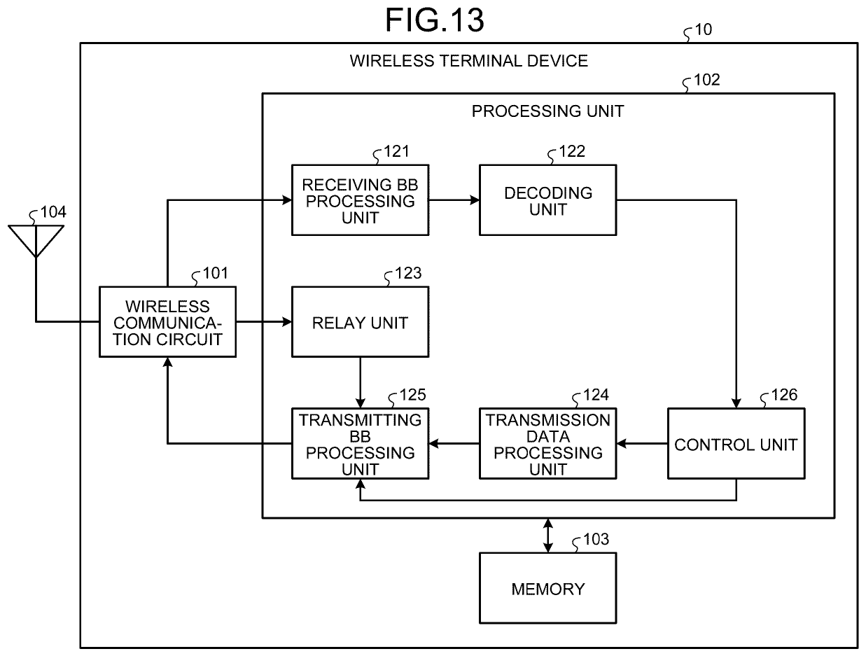

FIG. 13 is a block diagram of the wireless terminal device with a different relay method. The wireless terminal device 10 illustrated in FIG. 13 performs signal relay by amplify and forward (AF), in which the received wireless signal is amplified as it is and transmitted from the antenna 104.

In the wireless terminal device 10 illustrated in FIG. 13, in uplink data transmission, the relay unit 123 receives uplink data converted into a baseband signal from the wireless communication circuit 101. The relay unit 123 then outputs the acquired uplink data baseband signal to the transmitting BB processing unit 125.

The transmitting BB processing unit 125 receives the uplink data baseband signal, which has not been demodulated or decoded, from the relay unit 123. The transmitting BB processing unit 125 then performs phase control of the uplink data to the set phase. The transmitting BB processing unit 125 then outputs the phase-controlled uplink data baseband signal to the wireless communication circuit 101.

In this case, the RU 20 also measures the reception quality of the reference signal transmitted from each wireless terminal device 10, selects the RU 20 with the best reception quality as a reference wireless station, and notifies each wireless terminal device 10 of the phase setting obtained from the weight added in the reference wireless station RU 20.

As described above, even in the case of the wireless terminal device that performs signal relay by AF, the wireless terminal devices that perform coordinated transmission can improve the reception quality of uplink data at the RUs by adjusting the respective phases of the uplink data as appropriate to perform MIMO transmission. Since the RU with the high reception quality is selected as a reference wireless station from among a plurality of RUs, the reception quality of uplink data transmitted in a coordinated manner is improved. This configuration provides MIMO effects such as improved transmission capacity or reduced transmission power. In addition, the transmission rate can be improved. Accordingly, uplink communication performance can be improved.

### (b) Second Embodiment

A second embodiment will now be described. In MIMO multiplexing, the RU 20 according to the present embodiment determines distribution data to be distributed to each wireless terminal device 10 according to the reception quality between each wireless terminal device 10 and the RU 20, and allows the wireless terminal devices 10 to transmit uplink data. The RU 20 according to the present embodiment is also illustrated in the block diagram in FIG. 4. In the following description, the operation of each unit similar to that of the first embodiment will not be further elaborated.

After a reference wireless station is determined, the control unit 224 in the RU 20 selected as the reference base station compares the reception quality of the reference signal from each wireless terminal device 10. The control unit 224 then determines the amount of distribution data to be distributed to each wireless terminal device 10 according to the reception quality. The control unit 224 then instructs the transmission data processing unit 225 to notify the wireless terminal device 10 that is a source of uplink data of the determined amount of distribution data to be distributed to each wireless terminal device 10.

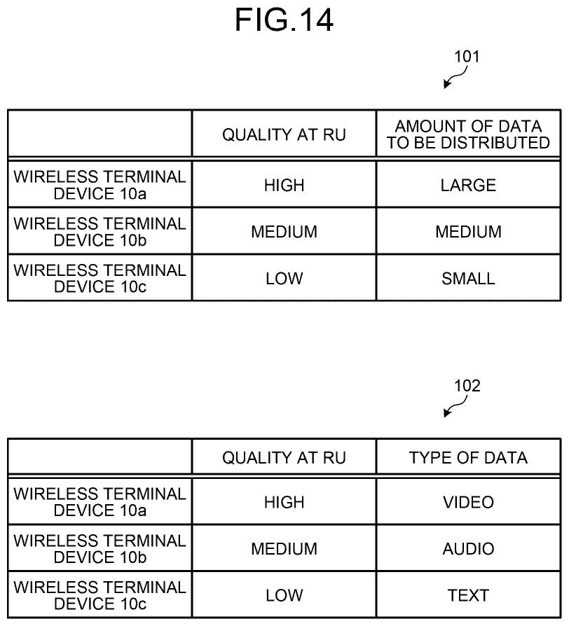

FIG. 14 is a diagram illustrating an example of data distribution according to the second embodiment. For example, it is assumed that the wireless terminal devices 10a to 10c perform coordinated transmission and that the wireless terminal device 10a has the highest reception quality, the wireless terminal device 10b has the next highest reception quality, and the wireless terminal device 10c has the lowest reception quality, as illustrated in table 101 in FIG. 14. Here, it is assumed that the source of uplink data is the wireless terminal device 10a.

In this case, as illustrated in table 101, the control unit 224 sets the amount of data to be distributed to the wireless terminal device 10a to “large”, which is the largest, sets the amount of data to be distributed to the wireless terminal device 10b to “medium”, which is the next largest, and sets the amount of data to be distributed to the wireless terminal device 10c to “small”, which is the smallest. The control unit 224 then notifies the wireless terminal device 10a of information on the determined amounts of data to be distributed to the wireless terminal devices 10a to 10c.

Upon receiving notification of the information on the amounts of data to be distributed, the control unit 126 of the wireless terminal device 10a determines uplink data to be transmitted from the wireless terminal device 10a itself, uplink data to be transmitted by the wireless terminal device 10b, and uplink data to be transmitted by the wireless terminal device 10c, according to the distribution of the notified amounts of data.

The control unit 126 then instructs the transmission data processing unit 124 to transmit to the RU 20 the uplink data to be transmitted from the wireless terminal device 10a itself. The control unit 126 also instructs the transmission data processing unit 124 to transmit to the wireless terminal device 10b the uplink data to be transmitted by the wireless terminal device 10b. The control unit 126 also instructs the transmission data processing unit 124 to transmit to the wireless terminal device 10c the uplink data to be transmitted by the wireless terminal device 10c.

### Modifications

In a modification, the control unit 224 of the RU 20 may determine the type of data to be distributed to each wireless terminal device 10 according to the comparison result of the reception quality. In this case, the control unit 224 instructs the transmission data processing unit 225 to notify the wireless terminal device 10 that is a source of uplink data of the determined type of distribution data to be distributed to each wireless terminal device 10.

For example, it is assumed that the wireless terminal devices 10a to 10c perform coordinated transmission and that, as indicated in table 102 in FIG. 14, the wireless terminal device 10a has the highest reception quality, the wireless terminal device 10b has the next highest reception quality, and the wireless terminal device 10c has the lowest reception quality. Again, it is assumed that the source of uplink data is the wireless terminal device 10a.

As illustrated in table 102, the control unit 224 sets the distribution data to be distributed to the wireless terminal device 10a to “video” of large size, sets the distribution data to be distributed to the wireless terminal device 10b to “audio” of medium size, and sets the distribution data to be distributed to the wireless terminal device 10c to “text” of small size. The control unit 224 then notifies the wireless terminal device 10a of information on the determined types of distribution data to be distributed to the wireless terminal devices 10a to 10c.

The control unit 126 of the wireless terminal device 10a receives notification of information on the types of distribution data to be distributed. The control unit 126 then sets the uplink data to be transmitted from the wireless terminal device 10a itself as video, the uplink data to be transmitted by the wireless terminal device 10b as audio, and the uplink data to be transmitted by the wireless terminal device 10c as text, according to the distribution of the notified types of distribution data. The control unit 126 then transmits, to the wireless terminal devices 10b and 10c, voice data and text data to be transmitted by the wireless terminal devices 10b and 10c. The control unit 126 allows the transmission data processing unit 124 to transmit video data.

As described above, the RU according to the present embodiment and modifications thereof determines distribution data to be distributed to each wireless terminal device according to the reception quality for each wireless terminal device at the reference wireless station and notifies the wireless terminal device that is a source of uplink data. Upon receiving the notification, the wireless terminal device executes coordinated transmission of uplink data together with other wireless terminal devices, according to the specified distribution.

This configuration can increase uplink data to be transmitted from the wireless terminal device with higher reception quality, and further improve the transmission rate. In other words, in MIMO multiplexing, the improved transmission capacity or reduced transmission power of the terminal can be achieved by improving the reception quality in the RU of a signal transmitted from each wireless terminal device and by optimizing the amount of distribution of transmission data to each terminal according to the reception quality. Accordingly, uplink communication performance can be improved.

### Hardware Configuration

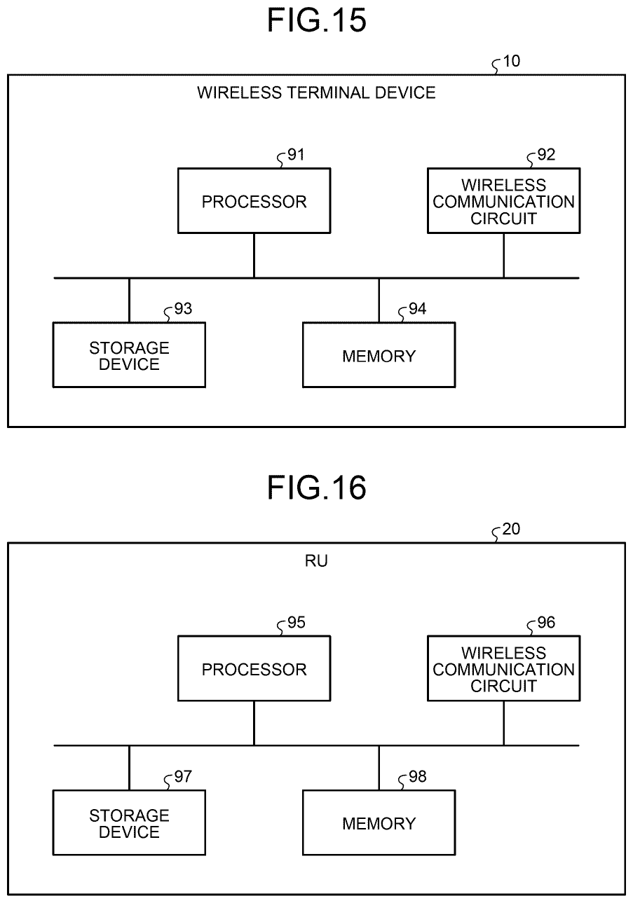

FIG. 15 is a diagram illustrating an example of a hardware configuration of the wireless terminal device. For example, as illustrated in FIG. 15, the wireless terminal device 10 has a processor 91, a wireless communication circuit 92, a storage device 93, and a memory 94. The processor 91 is connected to the wireless communication circuit 92, the storage device 93, and the memory 94 via a bus.

The storage device 93 is, for example, a hard disk. The storage device 93 stores various computer programs, including a computer program that implements the processing executed by the processor 91.

The memory 94 implements the function of the memory 103. For example, the memory 94 temporarily stores a signal being processed.

The processor 91 reads and executes various computer programs stored in the storage device 93 to implement, for example, the functions of the receiving BB processing unit 121, the decoding unit 122, the relay unit 123 in the case of DF, the transmission data processing unit 124, the transmitting BB processing unit 125, and the control unit 126.

The wireless communication circuit 92 implements, for example, the functions of the wireless communication circuit 101 and the relay unit 123 in the case of AF.

FIG. 16 is a diagram illustrating an example of a hardware configuration of the RU. For example, as illustrated in FIG. 16, the RU 20 has a processor 95, a wireless communication circuit 96, a storage device 97, and a memory 98. The processor 95 is connected to the wireless communication circuit 96, the storage device 97, and the memory 98 via a bus.

The storage device 97 is, for example, a hard disk. The storage device 97 stores various computer programs, including a computer program that implements the processing executed by the processor 95.

The memory 98 implements the function of the memory 203. For example, the memory 98 temporarily stores a signal being processed.

The processor 95 reads and executes various computer programs stored in the storage device 97 to implement, for example, the functions of the receiving BB processing unit 221, the MIMO processing unit 222, the decoding unit 223, the control unit 224, the transmission data processing unit 225, and the transmitting BB processing unit 226.

The wireless communication circuit 96 implements, for example, the function of the wireless communication circuit 201.

According to one aspect of the base station device, the wireless terminal device, the wireless communication system, and the communication control method disclosed in this application, uplink communication performance can be improved.

All examples and conditional language recited herein are intended for pedagogical purposes of aiding the reader in understanding the disclosure and the concepts contributed by the inventors to further the art, and are not to be construed as limitations to such specifically recited examples and conditions, nor does the organization of such examples in the specification relate to a showing of the superiority and inferiority of the disclosure. Although the embodiments of the present disclosure have been described in detail, it should be understood that the various changes, substitutions, and alterations could be made hereto without departing from the spirit and scope of the disclosure.

What is claimed is:

1. A base station device comprising a plurality of wireless stations,
the wireless stations each including:
a receiver that receives signals transmitted from a plurality of wireless terminal devices that transmit transmission data in a coordinated manner; and
a controller that selects a reference wireless station from among the wireless stations, determines a phase of the transmission data for each of the wireless terminal devices at the selected reference wireless station, and notifies the wireless terminal devices of the determined phase.

2. The base station device according to claim 1, wherein the controller selects the reference wireless station from among the wireless stations, based on reception quality of the signals received by the receiver.

3. The base station device according to claim 1, wherein the controller determines a phase of the transmission data for each of the wireless terminal devices, based on reception quality at the selected reference wireless station.

4. The base station device according to claim 1, wherein
the receiver receives reference signals from the wireless terminal devices, and
the controller measures reception quality of the reference signals and selects the reference wireless station based on a measurement result.

5. The base station device according to claim 4, wherein the controller generates a combined signal by performing weighted combining for the reference signals, measures reception quality of the combined signal, and sets the measured reception quality as the reception quality of the reference signals.

6. The base station device according to claim 5, wherein the controller selects the reference wireless station from the wireless station device with higher reception quality of the reference signal.

7. The base station device according to claim 1, wherein the controller determines the phase of the transmission data for each of the wireless terminal devices so that reception quality at the reference wireless station is largest.

8. The base station device according to claim 1, wherein the controller determines distribution data to be distributed to each of the wireless terminal devices, in the transmission data to be transmitted in a coordinated manner, based on reception quality at the reference wireless station for each of the wireless terminal devices, and notifies the wireless terminal device of the distribution data for each of the wireless terminal devices.

9. A wireless terminal device from among a plurality of the wireless terminal devices transmitting transmission data in a coordinated manner, the wireless terminal device comprising:
a controller that receives a phase setting of the transmission data determined at a reference wireless station selected from among a plurality of wireless stations of a base station device; and
a transmitter that performs phase control based on the phase setting received by the controller, and transmits the transmission data.

10. The wireless terminal device according to claim 9, wherein the controller receives a phase setting of the transmission data determined at the reference wireless station selected from among the wireless stations based on reception quality of signals sent from the wireless terminal devices.

11. The wireless terminal device according to claim 9, wherein the controller receives a phase setting of the transmission data determined based on reception quality at the selected reference wireless station.

12. A wireless communication system comprising: a plurality of wireless terminal devices that transmit transmission data in a coordinated manner; and a base station device including a plurality of wireless stations that receive the transmission data transmitted in a coordinated manner from the wireless terminal devices,
the wireless stations each including
a receiver that receives signals transmitted from the wireless terminal devices, and
a first controller that selects a reference wireless station from among the wireless stations, determines a phase of the transmission data for each of the wireless terminal devices at the selected reference wireless station, and notifies the wireless terminal devices of the determined phase,
the wireless terminal devices each including
a second controller that receives a phase setting of the transmission data from the reference wireless station, and
a transmitter that performs phase control based on the phase setting received by the second controller and transmits the transmission data.

13. The wireless communication system according to claim 12, wherein the first controller selects the reference wireless station from among the wireless stations based on reception quality of the signals received by the receiver.

14. The wireless communication system according to claim 12, wherein the first controller determines a phase of the transmission data for each of the wireless terminal devices based on reception quality at the selected reference wireless station.
